(19) United States
(12) Patent Application Publication
(10) Pub. No.: US 2013/0082838 A1
(43) Pub. Date: Apr. 4, 2013

(54) Method and system for redundant wireless delivery of fire suppression event data

(71) Applicant: Numerex Corp., Atlanta, GA (US)

(72) Inventor: Wesley Watts, Dallas, GA (US)

(73) Assignee: Numerex Corp., Atlanta, GA (US)

(21) Appl. No.: 13/573,679

(22) Filed: Oct. 3, 2012

Related U.S. Application Data
(60) Provisional application No. 61/542,528, filed on Oct. 3, 2011.

(51) Int. Cl. G08B 1/00

(52) U.S. Cl. 340/539.16; 340/531

(57) ABSTRACT

A system for redundant delivery of fire suppression event data is described that includes a sprinkler system connected to a plurality of sprinkler heads through riser pipes used to carry a fire suppression medium, wherein the sprinkler system includes an event reporting interface. An alarm event reporting system is connected to the sprinkler system using the event reporting interface, where the alarm event reporting system has a first communications interface and a second communications interface. The alarm event reporting system communicates with a central monitoring system using the first communications interface or the second communications interface, such that communications between the alarm event reporting system and the central monitoring system are maintained in the event of a failure in one of the communications paths.

### CROSS REFERENCE TO RELATED INFORMATION

This application claims the benefit of U.S. Provisional Patent Application No. 61/542,528, filed Oct. 3, 2011, the contents of which are hereby incorporated herein in their entirety.

### TECHNICAL FIELD

The present invention relates generally to premise alarm systems, and more particularly to a system and method for redundant transport of critical life, health and safety data from monitored premises to one or more predetermined monitoring authorities.

### BACKGROUND OF THE INVENTION

Early fire suppression sprinkler alarm systems, such as that claimed by Queen's 1937 U.S. Pat. No. 2,153,875 taught a mechanically operated alarm system, such as a bell, mechanically operated by the force of water moving within a pipe, and their utility was local and limited to detection by hearing the audible sound of the bell. Another early patent was Dawson's 1933 U.S. Pat. No. 2,056,345 that claimed a sprinkler head with an electrical contact for triggering a remote alarm in response to temperature increase indicative of a fire. Fire suppression sprinkler systems were improved in 1957 with Hube's U.S. Pat. No. 2,891,625, which taught detection of a reportable alarm event by detecting a decrease in pressure due to water flow in the fire suppression sprinkler system and closing an electrical switch contact as means for reporting such an event to an external annunciator system.

While the basic functionality of alarm reporting capability of fire suppression sprinkler alarm systems remains basically the same as taught by Hube's '625, modern systems have interfaced the electrical alarm contact to security premise alarm systems in order to report alarm events to central monitoring stations. Such existing security premise alarm systems transport alarm event data via single non-redundant path.

Existing systems typically utilize audio tones over wireline telephony. Some more modern security premise alarm systems designed for UL commercial fire installations report event alarm data via computer networking, typically using the Ethernet standard, or in some cases, wireless data transport using cellular based, including such systems that utilize the GSM or CDMA standards in combination with commercial wire-line telephone, where the wireless system is used when the wire-line connection is nonfunctional. The DSC product marketed as “GS3055-ICF GSM Universal Wireless Commercial Fire Alarm Communicator” is an example of such as system.

Other modern security premise alarm systems report event alarm data solely via wireless telecommunications, including the GSM or CDMA standards, utilizing a single wireless communication connection to convey event data. The aforementioned DSC product, the GS3055-ICF, can be configured and operated as an example of such a prior art system, communicating wirelessly using Internet Protocol (IP). Such systems comply with National Fire Protection Association (NFPA) requirements for “Other Transmission Technologies” do not require the use of a second communication channel if they are “always on” and are required to indicate failure of the communications path at the supervision station within five minutes of the failure. “Always on” typically means a poll/response communications every five minutes.

### BRIEF SUMMARY OF THE INVENTION

A system for redundant delivery of fire suppression event data is described. The system includes a sprinkler system connected to a plurality of sprinkler head through riser pipes used to carry a fire suppression medium, wherein the sprinkler system includes an event reporting interface. An alarm event reporting system is connected to the sprinkler system using the event reporting interface, where the alarm event reporting system includes a first communications interface and a second communications interface. The alarm event reporting system is operable to communicate with a central monitoring system over a first communications path using the first communications interface and a second communications path using the second communications interface, such that communications between the alarm event reporting system and the central monitoring system are maintained in the event of a failure in the first communications path or the second communications path.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of a preferred embodiment of an alarm system configuration according to the concepts described herein.

### DETAILED DESCRIPTION OF THE INVENTION

Prior designs for UL commercial fire installations that utilize a wholly wireless transport path system must be polled every few minutes to conform to NFPA requirements as an “always on” communications path. These prior designs are deficient for delivery of time sensitive fire suppression sprinkler alarm event data due to the inherently higher costs associated with (1) the provision of a commercial telephone; (2) frequent wireless messaging.

The concepts described herein enable redundant wireless transport of critical life, health and safety data from monitored premises to one or more predetermined monitoring authorities utilizing a wholly wireless, dual redundant system that monitors communications viability and incorporates automatic transport path switching to insure reliable event data delivery.

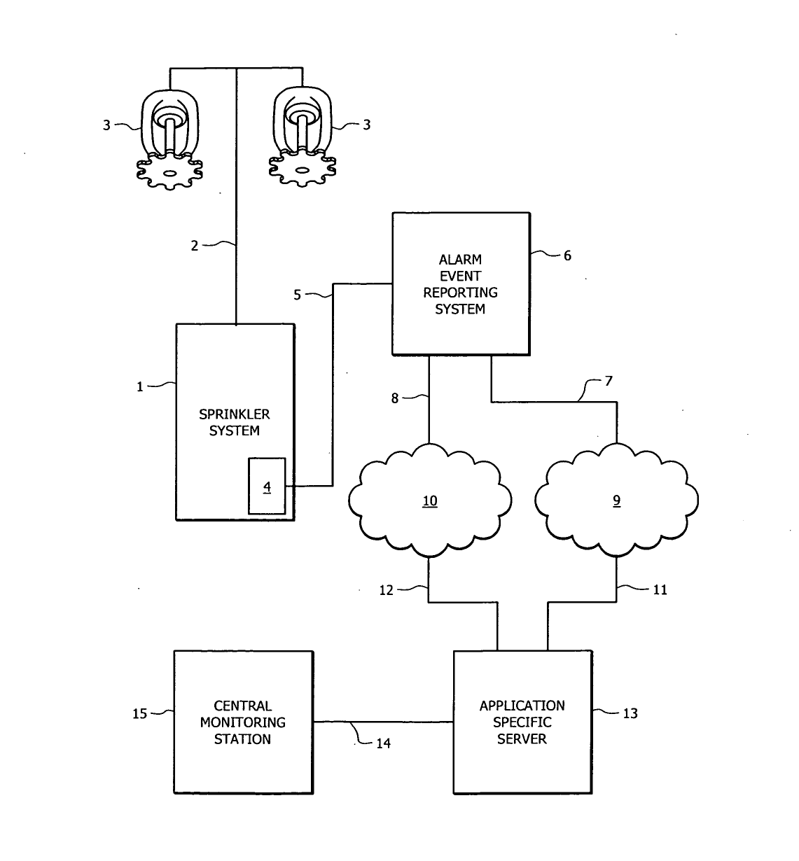

FIG. 1 illustrates a preferred embodiment of the invention, the sequence and method of interaction of which is described herein. In the event of a fire in the monitored premises, activation of one or more sprinkler heads 3 will cause sprinkler riser pipes 2 to be filled with fire suppression medium, typically water but inert gas is another option, by the sprinkler system 1 which is then dispersed from the activated sprinkler heads 3. In preferred embodiments, sprinkler system 1 detects that dispersal of fire suppression medium has occurred, it closes electrical contacts at its alarm event reporting interface 4, though other alarm activation mechanisms would also be compatible with the concepts described herein. The electrical contacts of alarm event reporting interface 4 indicate sprinkler riser flow but may also include contacts for trouble, tamper and test.

The alarm event reporting system 6 receives the alarm event from alarm event reporting interface 4 via connection 5, which can be electrical wiring, wireless interface, mechanical interface or other suitable mechanism. The alarm event reporting system 6, upon detection of a reportable alarm event preferably utilizes integrated radio transceivers to initiate transmission of such alarm events over either radio-telecommunications path 7 or radio-telecommunications path 8. The technology of radio-telecommunications path 7 or radio-telecommunications path 8 for the preferred embodiment is CDMA for one and GSM for the other and the preferred transport protocol is Short-Message-Service (SMS), although it should be clear to those skilled in the art that other radio-telecommunications technologies, such as, but not limited to Long Term Evolution (LTE), mobile WiMAX, short range radio, or any other suitable wireless technology can be used and as well as other message protocols. The alarm event reporting system 6 preferably selects which radio-telecommunications path 7 or 8 in an alternating method whereby the one selected is different from that last selected, though any selection method can be used. Should one of the radio-telecommunications paths be non-functional, then the other radio-telecommunications path will be selected. If radio-telecommunications path 7 is selected then commercial radio-telecommunications service provider 9 will be utilized to deliver the alarm event data to application specific server 13 over communications circuit 11, or if radio-telecommunications path 8 is selected then radio-telecommunications 10 will be utilized to deliver the alarm event data to application specific server 13 over communications circuit 12.

Application specific server 13 correlates the received alarm with a subscribing customer's account and then delivers the alarm event data to a central monitoring station 15 via communications path 14. In the preferred embodiment, communications path 14 is analog telephone phone call over the public switched telephone network although it should be clear to those skilled in the art that communications path 14 could also be VoIP, wire-line Internet, IP over cellular, private radio or a plethora of other industry standard telecommunication services. In the preferred embodiment, communications path 14 transmits the alarm signal using an alarm industry standard analog signaling protocol, like Contact ID.

Due to the dual communication paths of the invention, frequent, periodic non-alarm communications, such as every five minutes, are not necessary under the NFPA requirements. Instead, in the preferred embodiment, non-alarm communication are initiated just once every twenty-four hours or as required by appropriate industry standards. This change in reporting frequency resulting from the dual path structure results in significantly reduced operating costs for the alarm system by reducing wireless carrier charges. Each transmission preferably utilizes an alternate use of the radio-telecommunications path 7 or 8 such that if radio-telecommunications path 7 was previously selected for the most recent non-alarm communications then radio-telecommunications path 8 is selected next. However, based on network costs, one of the communications interfaces can be selected as a “preferred” interface and used unless it is inoperative. While sprinkler system 1, its alarm event reporting interface 4 and alarm event reporting system 6 are shown in FIG. 1 and described herein as separate components, other embodiments of this invention can integrate their functionality to reduce space, lower power requirements and ease installation.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for redundant delivery of fire suppression event data comprising:
a sprinkler system connected to a plurality of sprinkler head through riser pipes used to carry a fire suppression medium, wherein the sprinkler system includes an event reporting interface;
an alarm event reporting system connected to the sprinkler system using the event reporting interface, the alarm event reporting system having a first communications interface and a second communications interface;
wherein the alarm event reporting system is operable to communicate with a central monitoring system over a first communications path using the first communications interface and a second communications path using the second communications interface, such that communications between the alarm event reporting system and the central monitoring system are maintained in the event of a failure in the first communications path or the second communications path.

2. The system of claim 1 wherein the first communications path is a CDMA network.

3. The system of claim 1 wherein the second communications path is a GSM network.

4. The system of claim 1 wherein the alarm event reporting system and the event reporting interface of the sprinkler system are integrated into a single component.

5. The system of claim 1 wherein the alarm event reporting system alternates message reporting between the first communications interface and the second communications interface.

6. The system of claim 1 wherein the first communications interface is the preferred communications interface.

7. The system of claim 1 further comprising an application specific server at the termination of the first communications path and the second communications path, wherein the application specific server is in communication with the central monitoring system.

8. The system of claim 1 wherein the alarm event reporting system can be integrated into existing sprinkler systems to implement dual wireless communication paths.

9. A system for delivery of premise alarm data comprising:
an alarm system including an event reporting interface;
an alarm event reporting system connected to the alarm system using the event reporting interface, the alarm event reporting system configured to have a first wireless communications interface and a second wireless communications interface;
wherein the alarm event reporting system is operable to communicate with a central monitoring system over a first communications path using the first communications interface and a second communications path using the second communications interface, such that communications between the alarm event reporting system and the central monitoring system are maintained in the event of a failure in the first communications path or the second communications path.

10. The system of claim 9 wherein the alarm system includes a sprinkler system connected to a plurality of sprinkler head through riser pipes used to carry a fire suppression medium, the event reporting interface activated when the fire suppression medium is detected to be flowing in the riser pipes.

11. The system of claim 9 wherein the first communications path is a CDMA network.

12. The system of claim 9 wherein the second communications path is a GSM network.

13. The system of claim 9 wherein the alarm event reporting system and the event reporting interface of the sprinkler system are integrated into a single component.

14. The system of claim 9 wherein the alarm event reporting system alternates message reporting between the first communications interface and the second communications interface.

15. The system of claim 9 wherein the first communications interface is the preferred communications interface.

16. The system of claim 9 further comprising an application specific server at the termination of the first communications path and the second communications path, wherein the application specific server is in communication with the central monitoring system.

17. The system of claim 9 wherein the alarm event reporting system can be integrated into existing sprinkler systems to implement dual wireless communication paths.
